(19) United States
(12) Patent Application Publication
(10) Pub. No.: US 2003/0016000 A1
(43) Pub. Date: Jan. 23, 2003

(54) Power supply circuit

(76) Inventor: Samuel Navarro Sanchez, Grenoble (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/188,317

(22) Filed: Jul. 3, 2002

(30) Foreign Application Priority Data
Jul. 3, 2001 (EP) 01410081.2

(51) Int. Cl. G05F 1/40

(52) U.S. Cl. 323/284

(57) ABSTRACT

A power supply includes a DC to AC converter with a switched power supply and a DC to AC converter that drives a load terminal via a first low pass filter having a 6 dB per octave response. A second low pass filter, having a 3 dB per octave response, is connected to the load terminal to drive one input of a comparator having another input responsive to a replica of the load terminal DC voltage. The comparator responds to a sudden increase in load terminal current to derive an output that closes a switch to supply additional DC current to the load terminal.

The present invention generally relates to electrical power supply circuits.

### BACKGROUND OF THE INVENTION

Electrical power supply circuits frequently include a DC to AC converter, i.e., an inverter, and/or an AC to DC converter, i.e., a rectifier. Power supply circuits including a DC to AC converter which drives an AC to DC converter are referred to as DC to DC converters. One type of DC to AC converter employed in DC-DC converters includes a pair of switches, such as a pair of power transistors, powered by a DC source and controlled by pulse width modulated signals. The AC output of the DC to AC converter drives an AC to DC converter including a rectifier and a low pass filter (LPF) including a shunt smoothing capacitor and a series resistor and/or smoothing inductor. A PF with a series inductor is preferred because it has greater smoothing than a series resistor, to provide a 6 db/octave rolloff, rather than a 3 db/octave rolloff. Such an AC to DC converter delivers an appropriate DC output voltage which is fixed or variable, depending on the duty cycle of the pulse width modulated signal.

One prior art DC-DC converter includes a current-boost circuit or glitch suppressor comprising an additional switch, such as another power transistor which is turned on and off according to sudden current demands from loads powered by the DC-DC converter. The switch is connected to the output of the AC to DC converter and an additional DC source and a load without causing an excessive decrease of the DC power supply output voltage. Such a current-boost circuit allows the global capacitance of the smoothing capacitor(s) associated with the power supply unit to be decreased, resulting in a decrease in the number of such capacitors to save cost and space.

An example of such circuit is described in a datasheet “High-Speed Step-Down Controller with Synchronous Rectification for CPU Power,” MAX 1638 issued by the U.S. company Maxim Integrated Products.

A resistor in series with the current-boost transistor decreases the overall performance of the current-boost circuit, because the current boost capability is limited by the resistor.

Another drawback of existing current boost circuits is that, if the DC output voltage has high noise content, the current-boost transistor is likely to be switched on and off very often and at a possibly very high frequency. The frequency at which the current boost transistor switch is turned on and off depends on noise peaks present in the output voltage. The transistor is therefore subject to undesirable overheating.

DC-DC converter based power supply units, in particular for computer microprocessor loads, can deliver variable DC voltages according to the current drawn by the microprocessor. This variable voltage feature, by lowering the power supply voltage while a high current is drawn, typically avoids applying an over-voltage to the microprocessor when the current sharply decreases. Conversely, by increasing the power supply voltage while a low current is drawn, the variable voltage feature avoids applying to the microprocessor excessively low voltage when the current sharply increases.

A further drawback with known current-boost circuits is that they are operable only with fixed voltage power supply circuits and cannot be employed with variable voltage power supply units as described above. This is because, as the DC output voltage decreases to follow a variable target voltage, a current boost transistor [THE ORIGINAL SAYS TRANSISTOR] performs voltage regulation on its own and is subject to overheating.

An object of the present invention is thus to provide a converter with a current-boost feature in which a current-boost switch, such as a transistor, is less exposed to overeating due to repeated switching, and still provides the required additional current.

Another objective of the present invention is to enable the current-boost feature to be implemented, if desirable, with variable voltage power supply units.

### SUMMARY OF THE INVENTION

In accordance with one aspect of the invention, a power supply including a new and improved AC to DC converter having a DC output terminal for driving a DC load and an AC input terminal. The converter comprises a rectifier circuit and a first low pass filter connected between the AC input terminal and the DC output terminal and circuitry for suddenly changing the DC current supplied to the DC output terminal in response to a sudden change in DC load at the DC output terminal. The circuitry includes (a) a second low pass filter connected to be responsive to the voltage at the DC output terminal, and (b) a comparator for comparing an indication of a replica of the DC voltage at the DC output terminal with an indication of a replica of the low pass filter DC output voltage. The circuitry responds to an output of the comparator to cause the sudden change in the supplied DC current.

The first low pass filter preferably has a 6 dB per octave rolloff response and the second low pass filter has a 3 dB per octave rolloff response.

The second low pass filter preferably includes a resistive voltage divider connected to be responsive to the voltage at the first output terminal for establishing the replica of the low pass filter DC output voltage as a certain percentage of the mean, i.e., average DC voltage of the DC output voltage of the converter.

In a preferred embodiment, the power supply includes a DC power source connected to drive a switching arrangement for supplying the AC to the AC input terminal. A controller varies the duty cycle of the switching arrangement in response to the DC load at the first output terminal.

The present invention provides, according to another aspect, a power supply unit comprising a first switching circuit associated with a reactive impedance (i.e., a capacitor and/or inductor) for causing to have a controlled DC output voltage, and a second switching circuit for selectively adding to the output a boost current in response to sudden increased current demands from a load powered by the power supply unit. The second switching circuit includes a switch which is connected directly to the output and a comparator for comparing an indication of the actual voltage at the output with a reference voltage obtained by lowering and filtering the actual voltage.

Preferably, a voltage divider connected to be responsive to the actual voltage causes the reference voltage to be lower than the actual voltage. Typically, a capacitor in shunt with the output of the divider filters the actual voltage.

Another aspect of the invention relates to a method of regulating the output voltage of a power supply unit by controlling switching of a first switching circuit associated with an impedance circuit for controlling a basic regulated DC output voltage. A reference voltage is generated by lowering and filtering the DC output voltage. The actual value of the DC output voltage is compared with the reference voltage to control a second switching circuit in order to supply to the output of the power supply unit with boost current.

The level of the reference voltage is preferably between 0.90 and 0.99 times the mean level of the actual voltage.

The present invention also provides the use of the method as defined above for powering electronic circuitry of a computer equipment.

### BRIEF DESCRIPTION OF THE DRAWING

A preferred but non-limiting embodiment of the present invention will now be described in detail with reference to the appended drawings, in which:

FIG. 1 is a schematic diagram of a power supply unit in accordance with a preferred embodiment of the invention; and

FIGS. 2A and 2B are timing diagrams helpful in describing the behavior of the circuit of FIG. 1 with noiseless and noisy output voltages, respectively.

### DETAILED DESCRIPTION OF THE DRAWINGS

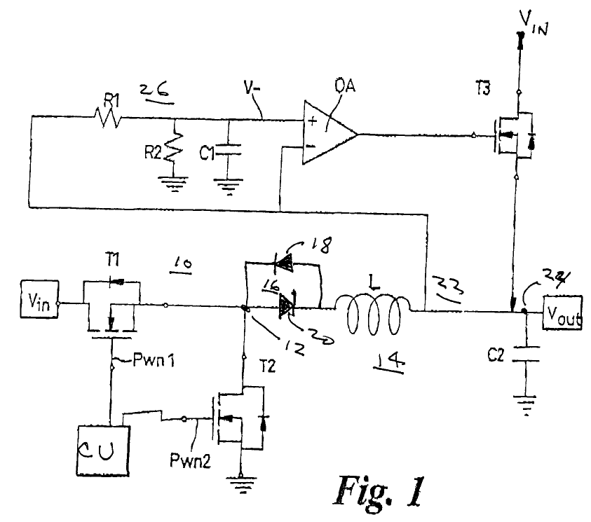

Referring to FIG. 1, a power supply circuit, in particular for computer equipment, comprises a DC to AC converter 10 connected to be responsive to an input DC voltage source Vin. Converter 10 includes series power switching transistor Ti and shunt switching transistor T2. Switching source respectively applies two oppositely phased width modulated (PWM) signals PWM1 and PWM2 to transistors T1 and T2 so that converter 10 supplies AC power to its output terminal 12. The voltage at terminal 12 drives AC to DC converter 14 including full wave rectifier 16 containing back to back power diodes 18 and 20. Rectifier 16 supplies pulsating DC to LPF 6 db/octave low pass filter (LPF) 22 including series smoothing capacitor C2. The resulting smoothed DC voltage (Vout) across C2, at terminal 24, drives a load, typically a computer microprocessor.

The known DC-DC converter including converters 10 and 14 generates a regulated output voltage Vout by appropriate feedback means (not shown). The smoothness and noise free character of voltage Vout is mainly determined by appropriate design and selection of inductor L and capacitors C2. These components are, in general, distributed at appropriate locations on a computer equipment motherboard and/or in a power supply unit.

The power supply unit additionally includes a current-boost transistor T3 which is connected directly between a DC voltage source Vin (or a different voltage source) and the Vout terminal 24. Transistor T3 is intended to allow the DC to DC power supply unit to meet sudden current demands which can occur in the operation of its computer equipment load. T3 is preferably an N-MOS power transistor.

A low pass filter 26 comprising a voltage divider including series-connected resistor R1 and shunt resistor R2 is connected between Vout and ground. The resistance values of R1 and R2 are selected so that the divider has a multiplying factor somewhat lower than 1, and preferably between 0.90 and 0.99 (e.g., approximately 0.95). LPF 26, which has a 3 db/octave rolloff so that it responds more quickly than the 6 db/octave rolloff of LPF 22, includes shunt capacitor C1, connected between a tap of divider R1, R2 and ground. LPF 26 filters a replica of the voltage at terminal 24 so the voltage across capacitor C1 is a smoothed version of the replica. The ungrounded terminal of capacitor C1 is connected to an inverting input of an operational amplifier OA which acts as a comparator. In this manner, capacitor C supplies the inverting input of amplifier OA with a reference voltage generated by lowering and low pass filtering the replica of the Vout voltage. This reference voltage is denoted V−. The non-inverting input of comparator OA is connected directly to Vout terminal 24 and thus is provided with an indication of the replica of the output voltage at terminal 24.

The output of comparator OA is connected to the base of transistor T3 so as to control the turning on and off of the latter. In the embodiment of FIG. 1, the input of T3 is inverted, whereby a high output of comparator OA turns off T3 while a low output of comparator OA turns on T3.

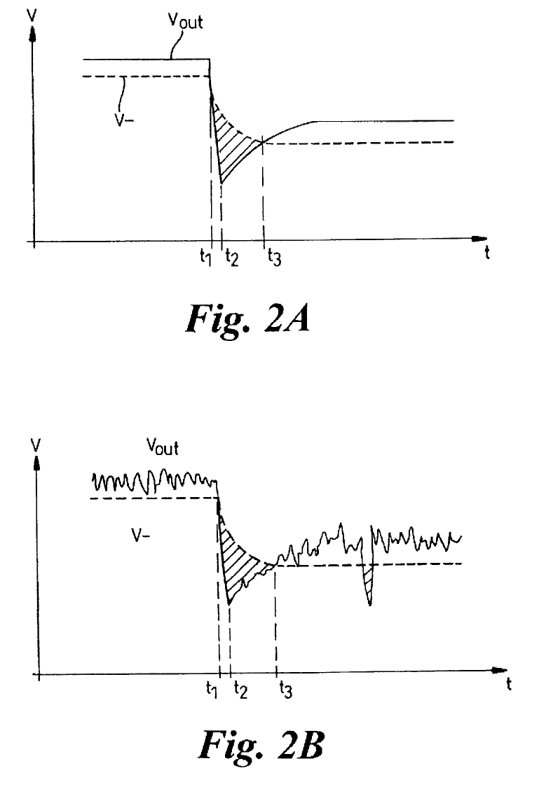

The operation of the circuit as shown in FIG. 1 is now described with reference to FIGS. 2A and 2B.

FIG. 2A includes waveforms for a situation where the output voltage Vout does not include noise.

On the left side of FIG. 2A, prior to time t1, a situation is illustrated where Vout is steady and V1 is at a level somewhat lower than Vout, as described above. For instance, Vout is at 5 volts while V− is at 4.75 volts in the example given in the foregoing. In this situation, comparator OA delivers a high level, whereby T3 is off, and the DC voltage, Vout at terminal 24, is regulated in the normal fashion by appropriate control of T1 and T2.

In response to Vout undergoing a sudden and substantial decrease as shown between times t1 and t2, Vout quickly goes lower than V−, which changes much more slowly than Vout due to the time constant of circuit R1, R2 and C1. In such situation, comparator OA delivers a low voltage level, whereby T3 is turned on to supply additional current (i.e., a boost current) from Vin to terminal 24 and to the load connected to Vout.

The boost current indicated by the hatched area in FIG. 2A causes Vout to start increasing from time t2, while V− continues to decrease.

When the Vout voltage at terminal 24 again increases above the V− voltage (time t3), comparator OA delivers a high level, to turn off T3 so that no more boost current is provided to Vout terminal 24.

From that moment, Vout and V− progressively stabilize to respective levels which are identical to or different from the original levels. In FIG. 2A, a situation has been shown where the new levels are different from the original ones.

This situation typically corresponds to the case where the power supply unit outputs a variable voltage and where the level of voltage Vout at terminal 24 is governed by the actual current consumption of the load equipment. In FIG. 2A, the new level of Vout is less than the original output because of increased load current consumption.

It can be understood from FIGS. 1 and 2A that the circuit of FIG. 1 is designed to operate independently of the actual voltage value of Vout. More particularly, in the right section of FIG. 2A, the circuit is operating in a regime where, although the voltage values of Vout and V− are different, the boost current supply is still able to operate in the same manner as described above. The main reason for this is that the voltage V− change depends on the voltage Vout.

FIG. 2B includes waveforms for the case where Vout has a mean value which corresponds to the situation of FIG. 2A, but is impacted by a variable amount of noise.

In the left part of FIG. 2B, prior to time t1, it can be seen that the noise level is too low to cause the Vout voltage at terminal 24 to go lower than V−. Thus comparator OA does not perform any action and T3 remains turned off. The level of V− remains steady during that time because the noise is substantially filtered out by capacitor C1.

The middle part of FIG. 2B, between t1 and t3, indicates that, despite the existence of noise, the behavior of the circuit remains essentially unchanged, i.e., transistor T3 is turned on to provide required boost current whenever necessary.

The right part of FIG. 2B, after t3, shows a high noise region. Here, the negative going noise peak brings the Vout voltage at terminal 24 under the steady V− level between times t4 and t5, whereby during this short period of time, the output of OA turns on T3 so Vin provides some boost current to terminal 24. However, it is understood that the relative level of V− (determined by the values of R1 and R2) can be readily adjusted to minimize the occurrence of such undesirable switching of T3, while allowing a prompt reaction when Vout sharply decreases due to a significant current demand.

Therefore, unnecessary switching of T3, which otherwise could occur at extremely high frequencies (depending on noise spectral contents), is avoided, and therefore overheating of T3 is also avoided.

Although the invention has been described by way of example and with reference to particular embodiments it is to be understood that modification and/or improvements may be made without departing from the scope of the appended claims.

Where in the foregoing description reference has been made to integers or elements having any equivalents, then such equivalents are herein incorporated as if individually set forth.

1. A power supply unit comprising a first switching circuit associated with a reactive impedance for causing an output to have a controlled DC output voltage, and a second switching circuit for selectively adding to said output a boost current in response to sudden increased current demands from a load powered by said power supply unit, wherein said second switching circuit comprises a switch which is connected directly to said output and a comparator for comparing an indication of the actual voltage at said output with a reference voltage obtained by lowering and filtering said actual voltage.

2. A power supply unit according to claim 1, comprising a voltage divider connected to be responsive to said actual voltage at an input for lowering said actual voltage.

3. A power supply unit according to claim 2, comprising a capacitor in shunt with the output of said divider for filtering said actual voltage.

4. A power supply unit according to claim 3, wherein said comparator has a first input connected to be responsive to the output of said divider and a second input connected to be responsive to the output of the first switching circuit.

5. A power supply unit according to claim 1, wherein the level of said reference voltage is between 0.90 and 0.99 times the mean level of said actual voltage.

6. A power supply unit according to claim 1, wherein said first switching circuit is controllable so as to vary the mean value of the DC output voltage.

7. A method of regulating the output voltage of a power supply unit comprising the following steps:
controlling the switching of a first switching circuit associated with an impedance circuit for controlling a basic regulated DC output voltage,
generating a reference voltage by lowering and filtering the DC output voltage,
comparing the actual value of the DC output voltage with said reference voltage, and
controlling a second switching circuit in response to the comparison step in order to supply a boost current to the output of the power supply unit.

8. A method according to claim 7, wherein the level of said reference voltage is between 0.90 and 0.99 times the mean level of said actual voltage.

9. A method according to claim 7, wherein the step of controlling the switching of the first switching circuit is performed so as to vary the mean value of the DC output voltage.

10. The use of the method according to claim 7 for powering electronic circuitry of a computer equipment.

11. A power supply including an AC to DC converter having a DC output terminal for driving a DC load and an AC input terminal, the converter comprising a rectifier and a first low pass filter connected between the AC input terminal and the DC output terminal, circuitry for suddenly changing the DC current supplied to the DC output terminal in response to a sudden change in DC load at the first output terminal, the circuitry including (a) a second low pass filter having an input terminal connected to be responsive to the voltage at the DC output terminal, and (b) a comparator for comparing an indication of a replica of the DC voltage at the DC output terminal with an indication of a replica of the DC voltage derived by the second low pass filter, the circuitry being arranged to be responsive to an output of the comparator to cause the sudden change in the supplied DC current.

12. The power supply of claim 11 wherein the first low pass filter has a 6 dB per octave response and the second low pass filter has a 3 dB per octave response.

13. The power supply of claim 12 wherein the second low pass filter includes a voltage divider connected to be responsive to the DC voltage at the DC output terminal.

14. The power supply of claim 13 wherein the voltage divider is resistive.

15. The power supply of claim 11 wherein the second low pass filter includes a voltage divider connected to be responsive to the DC voltage at the DC output terminal.

16. The power supply of claim 11 further including a DC to AC converter connected to drive the AC to DC converter, the DC to AC converter including a switching arrangement, and a controller for varying the duty cycle of the switching arrangement in response to the DC load at the first output terminal.
